(19) United States
(12) Patent Application Publication
(10) Pub. No.: US 2026/0284549 A1
(43) Pub. Date: Sep. 24, 2026

(54) CAUSTIC SOLUTION EVAPORATION PLANT

(71) Applicant: Bertrams Chemieanlagen AG, Muttenz (CH)

(72) Inventor: Max HOSTETTLER, Lostorf (CH)

(73) Assignee: Bertrams Chemieanlagen AG, Muttenz (CH)

(21) Appl. No.: 19/475,069

(22) PCT Filed: Apr. 15, 2024
(86) PCT No.: PCT/EP2024/060178

§ 371 Date: Oct. 14, 2025

(30) Foreign Application Priority Data
Apr. 14, 2023 (CN) 202320823859.7

(51) Int. Cl. B01D 1/26; B01D 1/00; B01D 5/00

(52) U.S. Cl. CPC B01D 1/26; B01D 1/0047; B01D 5/006; B01D 5/0075

(57) ABSTRACT

The invention relates to a caustic solution evaporation plant comprising a caustic solution feeding line, a first stage evaporator (EV-1101) receiving low concentrated caustic solution and operating at a reduced pressure of less than or equal to 0.15 bar, a second stage evaporator (EV-1201) receiving enriched caustic solution from the first evaporator (EV-1101) and operating at a reduced pressure of less than or equal to 0.5 bar, a third stage evaporator (EV-1301) receiving further enriched caustic solution from the second stage evaporator (EV-1201) and operating at a pressure of greater than or equal to 1.1 bar, a fourth stage evaporator (EV-1401) receiving further enriched caustic solution from the third evaporator (EV-1301) and operating under a pressure greater than 4.0 bar characterized in that the first stage evaporator (EV-1101) being heated by the vapours generated from the second stage evaporator (EV-1201), the second stage evaporator (EV-1201) being heated by the vapours generated from the third stage evaporator (EV-1301), the third stage evaporator (EV-1301) being heated by the vapours generated by the fourth stage evaporator (EV-1401), and the fourth stage evaporator (EV-1401) being heated by thermal oil, the thermal oil being circulated by a pump (P-6301) through an electric heater (H-6101) in a closed loop, a vapour condensate tank (T-7101) collecting vapour condensate from the first (EV-1101) second (EV-1201), and third stage evaporator (EV-1301), a water cooled surface condenser (C-7101) condensing vapour generated in the first stage evaporator (EV-1101), a pump (P7101) draining the vapour condensate tank (T-7101), and a product caustic solution exit line.

The invention relates to a caustic soda or potassium evaporation (hereinafter mentioned as caustic solution evaporation) plant comprising a caustic solution feeding line, a first stage evaporator receiving low concentrated caustic solution and operating at a reduced pressure of less than or equal to 0.15 bar, a second stage evaporator receiving enriched caustic solution from the first evaporator and operating at a reduced pressure of less than or equal to 0.5 bar, a third stage evaporator receiving further enriched caustic solution from the second stage evaporator and operating at a pressure of greater than or equal to 1.1 bar, and a fourth stage evaporator receiving further enriched caustic solution from the third stage evaporator and operating at a pressure of greater than 4.0 bar, the first stage evaporator being heated by the vapours generated from the second stage evaporator, the second stage evaporator being heated by the vapours generated from the third stage evaporator, the third stage evaporator being heated by the vapours generated by the fourth stage evaporator and the fourth stage evaporator being heated by thermal oil, the thermal oil being circulated by a pump through an electric heater in a loop, a vapour condensate tank collecting vapour condensate from the first, second and third stage evaporator, a water cooled surface condenser condensing vapour generated in the first stage evaporator, a pump draining vapour condensate tank and a product caustic solution exit line.

Caustic soda solutions (NaOH solutions) are mostly obtained by electrolysis in a membrane process as an 30% to 33% aqueous solution. It is known to concentrate such solutions in evaporation plants to an NaOH concentration of 50% by weight or more. It is a common practice to further concentrate such solutions in concentration plants with falling film concentrators to a practically anhydrous melt for further processing into flakes, pellets or prills. The same holds for caustic potash solutions (KOH solutions).

Known evaporation plants for aqueous caustic solutions operate frequently with three falling film evaporators in an “one-pass through” mode with an integrated vapour separator. The first two of the three falling film evaporators normally work under vacuum, the third one at an elevated pressure. Low concentrated caustic solution is fed to the first evaporator, which is heated by the vapours generated by the second evaporator. The enriched caustic solution from the first evaporator is fed to the second evaporator for further concentration, the second evaporator being heated by the vapours generated by the third evaporator. The product caustic solution from the second evaporator is fed to the third evaporator, which is heated by pressurised steam. Product caustic solution, steam and generated vapours are passed through heat exchangers in order to retain the heat within the plant.

The pressurised steam used in the third evaporator requires the shell side to be pressure safe up to at least 16 bar. In addition, steam of more than 200° C. must be provided. If no steam source is available in the plant, this requires a steam generator. High pressure steam requires safety and sealing provisions, which are costly. In particular, where no inherent steam source is available in a plant, a heating system independent from steam could be an option. However, this would require a new design for many of the components and the lines within the plant.

It is an object of the present invention to provide a plant for the concentration of caustic solutions which can be run independently from steam and thus avoids the provision of high pressure resistant evaporators. In addition, such plant should effectively use/recover energy from the heating system and the product line. This objective is met with the plant of claim 1.

The present caustic evaporation plant comprises four evaporators arranged in line. Preferably, at least one evaporator is a falling film evaporator, in particular, all four evaporators are falling film evaporators, which have been shown to be most effective for heating caustic solutions.

Low concentrated caustic solution is fed to a first stage evaporator, normally a membrane cell liquor with a concentration of 30% to 33% by weight. The first evaporator is run at a reduced pressure of less than or equal to 0.15 bar on the tube side, preferably at about 85 to 100 mbar. The first stage evaporator is heated by the vapours exiting from the second stage evaporator. The condensed heating vapourexiting the first stage evaporator is collected in a vapour condensate tank. The vapour generated from the caustic solution in the first stage evaporator is cooled down in a condenser and can either be discharged with the cooling water or transferred to the vapour condensate tank.

Enriched caustic solution of 35 to 36% from the first stage evaporator is passed on to the second stage evaporator, where it is heated by the vapours generated in the third stage evaporator. The second stage evaporator is run at a reduced pressure of less than or equal to 0.5 bar, preferably at about 320 to 400 mbar. The condensed heating vapour exiting the second stage evaporator is collected in the vapour condensate tank. The vapour generated in the second stage evaporator is used to heat the first stage evaporator.

The further enriched caustic solution of 38 to 40% from the second stage evaporator is passed on to the third stage evaporator, where it is heated by the vapours generated in the fourth stage evaporator. The third stage evaporator is run at an elevated pressure of greater than or equal to 1.1 bar, preferably in the range of 1.1 to 1.2 bar. The condensed heating vapour exiting the third stage evaporator is collected in the vapour condensate tank. The vapour generated in this third stage evaporator is used to heat the second stage evaporator.

The still further enriched caustic solution of 43 to 45% from the third stage evaporator is passed on to the fourth stage evaporator, where it is heated by thermal oil to a temperature of at least 230° C., preferably about 210 to 240° C. The fourth stage evaporator is run under a pressure of 4.8 to 5.3 bar, preferably at about 5.0 bar. The thermal oil is heated by an electric heater or fuel generated heater and run in a loop by means of a pump. The thermal oil exiting the fourth stage evaporator is still hot enough (175 to 190° C.) to be used in heat exchangers to partially heat up product caustic solution exiting the third, second and first stage evaporators before being recycled to the electric heater. Product caustic solution exiting the fourth stage evaporator has a caustic concentration of 50% by weight or more and will exit the plant after having transferred its heat to product leaving the third, second and first evaporators. The vapour generated in the fourth stage evaporator is used to heat the third stage evaporator.

The condensed heating vapours exiting the third, second and first stage evaporator are collected in a common vapour condensate tank. If exiting heating vapours are still hot enough, they may be used in part to supplement the heating vapour of a lower stage evaporator.

As indicated above, the vapour condensate tank may also receive the condensed vapour generated in the first stage evaporator after appropriate cooling, if this condensate is not discharged together with cooling water.

The thermal oil heating system for the fourth stage evaporator is run at ambient pressure. Thus, it is not necessary to provide a pressuresafe shell side for heating the product in the fourth stage evaporator.

In order to reduce the nickel corrosion of the equipment and thus the nickel pick up in the 50% lye, a corrosion inhibitor solution, e.g. borohydrate, bisulphite, hydrazine, will be dosed in the feed caustic. Other corrosion inhibitors are e.g. sugar, formic acid or formiate, hydrogene, the latter one in gaseous form.

Caustic solutions normally comprise small amounts of chlorate, which render caustic solutions with 50% caustic highly corrosive even for nickel, the preferred material for concentration equipment in that range. Corrosion inhibitors reduce or eliminate the chlorate content and prolong the service life of such equipment considerably.

The corrosion inhibitors can be fed into the original feed as a solution or in gaseous form (hydrogen), however, it is preferred to feed the corrosion inhibitor into feed, which is already enriched, but has not yet reached a 50% lye concentration. The feeding takes place best after the third stage evaporation into the line that connects the third stage evaporator with the feeding pump to the fourth stage evaporator.

The invention is further illustrated by the attached flow diagram.

In the preferred embodiment of

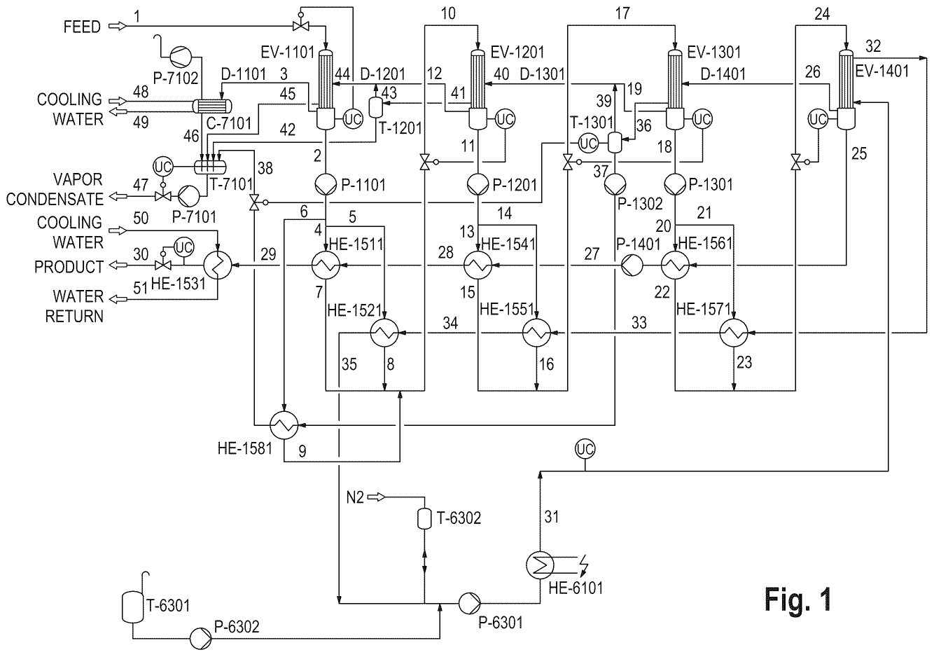

FIG. 1 the caustic solution evaporation plant of the invention comprises four falling film evaporators EV-1101, 1201, 1301 and 1401. The evaporators are arranged in line, the first stage evaporator EV-1101 being heated by the vapours generated in the second stage evaporator EV-1201 via line 12, the second stage evaporator EV-1201 being heated by the vapours generated in the third stage evaporator EV-1301 via line 19, and the third stage evaporator EV-1301 being heated by the vapours generated in the fourth stage evaporator EV-1401 via line 26. The fourth stage evaporator EV-1401 is heated by means of a thermal oil via line 31 and leaving the fourth stage evaporator EV-1401 via line 32. Spent condensed heating vapour leaves evaporator EV-1301 via line 36, evaporator EV-1201 via line 41 and evaporator EV-1101 via line 45. All spent condensed heating vapours are finally collected in tank T-7101, before exiting the plant via a pump P-7101 and line 47.

Evaporators EV-1101 and 1201 are run under a reduced pressure of 100 mbar and 400 mbar, respectively, while evaporators EV-1301 and 1401 are run under an elevated pressure of 1.2 bar and 5.0 bar, respectively. All while evaporators are falling film evaporators.

The feed is passed through line 1 to the first stage evaporator EV-1101, where it is concentrated to 33% caustic content. The concentrated caustic solution from EV-1101 is passed on to evaporator EV-1201 via line 2 and pump P-1101, entering the second stage evaporator via line 10. On its way to the second stage evaporator the caustic solution leaving the first stage evaporator is passed through line 4 through heat exchanger HE-1511 and/or via line 5 through heat exchanger age HE-1521 and/or via line 6 through heat exchanger HE-1581 before entering line 10 via line 7, 8 or 9, respectively. Heat exchanger HE-1511 is fed by product exiting the first stage evaporator EV-1401, heat exchanger HE-1581 by spent vapour exiting the third stage evaporator EV-1301 via line 36, tank T-1301, line 37, and pump P-1302, and heat exchanger HE-1521 by thermal oil leaving the shell side of evaporator EV-1401.

The concentrated caustic solution leaving second stage evaporator EV-1201 has a concentration of 36% and is passed to the third stage evaporator EV-1301 via line 11 and pump P-1201 to the third stage evaporator EV-1301. On its way to the third stage evaporator caustic solution is fed via line 13 to heat exchanger HE-1541 and/or via line 14 to heat exchanger HE-1551, where it takes up heat provided from all the product leaving the fourth stage evaporator or thermal oil from the force stage evaporator, respectively. The concentrated caustic solution then is passed via lines 15 and 16, thereafter line 17 to the third stage evaporator EV-1301.

In evaporator EV-1301 the caustic solution is concentrated from 36 to 45% caustic content. The concentrated caustic solution is fed via line 18 and pump P-1301 to the fourth stage evaporator EV-1401. To take up heat, the caustic solution is fed through lines 20 and 21 to heat exchangers HE-1561 and HE-1571, respectively, before entering through lines 22 and 23, respectively, line 24 and fourth stage evaporator EV-1401. Heat exchanger HE-1561 is heated by the product caustic solution leaving the fourth stage evaporator via line 25, while heat exchanger HE-1571 is heated by thermal oil leaving the 30 first stage evaporator via line 32. The product caustic solution leaving the fourth evaporator as a concentration of 50% caustic.

Corrosion inhibiting solution I fed into line 18 connecting the third stage evaporator EV-1301 and pump P-1301 (arrow), if necessary.

In this preferred embodiment of a plant according to the invention, heat from spent vapours as well as thermal oil and product leaving the fourth stage evaporator is mostly recovered in heat exchangers. Vapour leaving the first stage evaporator via line 3 is cooled down in cooler C-7101 by cooling water via lines 48 and 49, as is product caustic leaving the plant via line 29/30 in heat exchanger HE-1531.

Alternatively, a mixing condenser can be used as well, where the vapours are condensed directly into the cooling water and led as mixed water stream to battery limits. Inerts are sucked off by either a closed or open loop water-ring vacuum pump P-7102, or a steam ejector vacuum system. The closed loop water-ring vacuum system is often chosen to minimize the waste water amount. The circulating water will be cooled in a plate heat exchanger by chilled water.

The thermal oil used for heating evaporator EV-1401 is run in a closed loop starting with heater HE-6101, entering the fourth stage evaporator via line 31 and leaving via line 32. Before being recirculated to heater HE-6101, the thermal oil is passed through heat exchanger HE-5071 and line 33 to heat exchanger HE-1551 in order to deliver heat to the caustic solution leaving the third stage and the second stage evaporator, respectively. Thereafter the oil is fed through line 34 to heat exchanger HE-1521 to heat caustic solution leaving the first stage evaporator EV-1101, before being recirculated via pump P-6301 to heater HE-6101. Tank T-6301 and pump P-6302 feed thermal oil into the oil heating loop, when necessary, while tank T-6302 serves as an oil overflow tank.

In heater H-6101 the thermal oil is heated to a temperature of 210 to 235° C. In the course of the loop, after passing the fourth stage evaporator and the heat exchangers, the temperature of the thermal oil has dropped to 175 to 190° C.

Product caustic solution leaving the fourth evaporator EV-1401 via line 25 is passed subsequently through heat exchanger HE-1561, pump P-1401, line 27, heat exchanger HE-1541, line 28, heat exchanger HE-1511 and line 29 to heat exchanger HE-1531 connected to cooling water lines 50 and 51 before exiting the plant through line 30.

1. A caustic solution evaporation plant comprising a caustic solution feeding line,
a first stage evaporator (EV-1101) receiving low concentrated caustic solution and operating at a reduced pressure of less than or equal to 0.15 bar,
a second stage evaporator (EV-1201) receiving enriched caustic solution from the first evaporator (EV-1101) and operating at a reduced pressure of less than or equal to 0.5 bar,
a third stage evaporator (EV-1301) receiving further enriched caustic solution from the second stage evaporator (EV-1201) and operating at a pressure of greater than or equal to 1.1 bar,
a fourth stage evaporator (EV-1401) receiving further enriched caustic solution from the third evaporator (EV-1301) and operating under a pressure greater than 4.0 bar
the first stage evaporator (EV-1101) being heated by the vapours generated from the second stage evaporator (EV-1201), the second stage evaporator (EV-1201) being heated by the vapours generated from the third stage evaporator (EV-1301), the third stage evaporator (EV-1301) being heated by the vapours generated by the fourth stage evaporator (EV-1401), and the fourth stage evaporator (EV-1401) being heated by thermal oil, the thermal oil being circulated by a pump (P-6301) through an electric heater (H-6101) in a closed loop,
a vapour condensate tank (T-7101) collecting vapour condensate from the first (EV-1101) second (EV-1201), and third stage evaporator (EV-1301),
a water cooled surface condenser (C-7101) condensing vapour generated in the first stage evaporator (EV-1101),
a pump (P7101) draining the vapour condensate tank (T-7101), and
a product caustic solution exit line.

2. The plant of claim 1, wherein the temperature of the oil leaving the electric heater (HE-6101) is 210 to 235° C.

3. The plant according to claim 1, wherein at least one evaporator (EV-1101, 1201, 1301, 1401) is a falling film evaporator.

4. The plant according to claim 3, wherein the caustic solution leaving the fourth stage evaporator (EV-1401) is passed through at least one heat exchanger (HE-1571, 1551, 1521) to pre-heat intermediate caustic solution leaving the first, second and/or third stage evaporator (EV-1101, 1201, 1301).

5. The plant according to claim 1, wherein the caustic solution leaving the fourth stage evaporator (EV-1401) is passed successively through heat exchangers (HE-1571, 1551, 1521), for heating product exiting the third, second and first stage evaporators.

6. The plant according to claim 1, wherein the vapour condensate from the first stage evaporator (EV-1101) is discharged with the cooling water.

7. The plant according to claim 1, wherein the surface condenser (C-7101) is connected to the vapour condensate tank (T-7101) to drain condensate from the surface condenser (C-7101).

8. The plant according to claim 1, wherein the thermal oil heating the fourth stage evaporator (EV-1401) is at ambient pressure.

9. The plant of claim 1, designed to concentrate caustic soda solution from 32% or less to 50% or more.

10. The plant of claim 1 comprising a feeding line for dosing in corrosion inhibitor solution into caustic feed solution.

11. The plant of claim 10, wherein the feeding line for the corrosion inhibitor solution is dosed into the caustic solution entering the fourth stage evaporator (EV-1401).

12. The plant of claim 11, wherein the feeding line for the corrosion inhibitor solution enters line 18 feeding caustic solution from the third stage evaporator (EV-1301) to pump (P-1301).

13. The plant of claim 11, wherein the corrosion inhibitor solution comprises sugar, borohydrate, bisulfite, formic acid, formiate, hydrazine or gaseous hydrogen.
